(19) United States
(12) Patent Application Publication
(10) Pub. No.: US 2010/0232263 A1
(43) Pub. Date: Sep. 16, 2010

(54) CATEGORY MANAGEMENT

(76) Inventors: Jeff Kalis, Rockford, MI (US); Sterling Heibeck, Grand Rapids, MI (US); Steve Cummings, Howell, MI (US); Ron Richards, Elmhurst, IL (US)

Correspondence Address: DICKSTEIN SHAPIRO LLP, 1825 EYE STREET NW, Washington, DC, 20006-5403, US

(21) Appl. No.: 12/305,849

(22) PCT Filed: Jun. 26, 2007
(86) PCT No.: PCT/US07/14734

§ 371 Date: Dec. 19, 2008

Related U.S. Application Data
(60) Provisional application No. 60/816,880, filed on Jun. 28, 2006.

(51) Int. Cl. G11B 21/08

(52) U.S. Cl. 369/30.06; G9B/21.012

(57) ABSTRACT

An apparatus, system, and method for managing songs available for selection for play by a user is provided. Songs are assigned to one or more categories and time periods are set during which songs assigned to a category may be selected for play or may be blocked from being selected for play by a user.

### BACKGROUND

Jukeboxes are located in various public and private establishments, such as bars, restaurants, bowling alleys, and home computers, and provide hours of musical and video entertainment. Jukeboxes store large numbers of songs, videos and other forms of entertainment (“entertainment content”) that may be suitable or desirable for one category of consumers but not for others. For example, some entertainment content may only be suitable for people over the age of eighteen. Entertainment content may also not be culturally appropriate or desirable in a particular establishment (e.g., classical music in a country-western bar). A parent may wish to limit the ability of minor children to access certain categories of entertainment content on a home-based jukebox (e.g., personal computer). It may be desirable, therefore, for an administrator of a jukebox to control access to certain entertainment content according various criteria (e.g., time of day, age of listener, type of listener). For example, an administrator may wish to prelude songs that contain explicit lyrics from being selected for play during times when children are likely to be present, or to preclude holiday songs from being selected for play during other times of the year.

In the case of a jukebox that stores music on records or compact disks (CD), an administrator who wished to preclude a certain type of music or a certain song from being played may have to physically remove the record or CD containing the song from the jukebox. If the administrator wished to make the song available for play at a later time, the administrator would have to return the record or CD to the jukebox. This process of removing and returning songs to a jukebox can be time consuming and inconvenient.

In the case of a digital jukebox, the administrator may be required to delete the song from memory to prevent it from being played at an inappropriate time. Other systems are known in which songs may be precluded from play on a digital jukebox if the song is registered as containing explicit lyrics. However, these systems still require an administrator to access the jukebox system to manually block the songs when the administrator does not want the songs to be selected for play by a user and to access the jukebox again to unblock the songs when the administrator does want the songs to be available for selection for play by a user.

What is needed is a system and method to control access to entertainment content in a predetermined manner.

### BRIEF SUMMARY OF THE INVENTION

In various exemplary embodiments, the invention relates to a system and method for controlling a jukebox. One embodiment provides a method of controlling a jukebox comprising assigning songs to a category and preventing songs assigned to the category from playing during a first predetermined time period.

In one exemplary embodiment, the invention provides methods of controlling a jukebox, including assigning a song to a category; programming the jukebox to prevent songs assigned to the category from playing during a predetermined time period; and allowing songs assigned to the category to play during other time periods.

In another embodiment, the invention provides a program encoded on a computer readable medium for managing songs that may be played by a device. When the program is executed by a computer processor, the processor execute steps including allowing a person to select a category of songs to manage, the category of songs including of a plurality of songs having at least one common attribute; allowing a person to select a time period during which songs belonging to the category may not be played by the device; preventing the songs belonging to the selected category from being played by the device during the selected time period; and allowing the songs belonging to the selected category to play during other time periods.

Another exemplary embodiment provides a jukebox, including a memory storing a plurality of songs, at least some of the songs being assigned to a category; an audio output unit for playing the plurality of songs; and a processor for transferring the plurality of songs from the memory to the audio output unit; wherein the memory stores a computer program, which may be executed by the processor and cause the processor to prevent songs assigned to the category from playing during a predetermined time period and allow the songs assigned to the category to play during other times.

### BRIEF DESCRIPTION OF THE DRAWINGS

The foregoing and other aspects of the invention will be better understood from the following detailed description of the invention, which is provided in connection with the accompanying drawings, in which:

FIG. 1 is a diagram of a jukebox in accordance with an embodiment of the invention;

FIG. 2 is a flowchart of an exemplary method of managing a jukebox in accordance with the invention;

FIG. 3 is a picture of an exemplary touch screen showing a menu of categories in accordance with an embodiment of the present invention;

FIG. 4 is a picture of an exemplary touch screen showing an input screen in accordance with an embodiment of the invention.

FIG. 5 is a picture of an exemplary touch screen showing an input screen in accordance with an embodiment of the invention.

FIG. 6 is a picture of an exemplary touch screen showing a clock key pad input screen in accordance with an embodiment of the invention.

### DETAILED DESCRIPTION OF THE PREFERRED EMBODIMENTS

In the following detailed description, reference is made to the accompanying drawings, which form a part hereof and show by way of illustration specific embodiments in which the invention may be practiced. These embodiments are described in sufficient detail to enable those skilled in the art to practice the invention, and it is to be understood that other embodiments may be utilized, and that changes to the described embodiments may be made without departing from the spirit and scope of the present invention.

In the specification and claims that follow it should be understood that the term “song” is defined to encompass, for example, a recorded piece of music, and is also defined to encompass other fixed media content, including, but not limited to, video, audio, video games, and still pictures. Further, the term “jukebox” is defined to encompass any type of machine that is capable of storing and playing songs at a users request, including, but not limited to, a computer, an MP3 player, DVD player, digital video recorder (e.g. TIVO®) or a game machine. The term “programming” is defined to include making one or more adjustments to the hardware or software of a device to control the device.

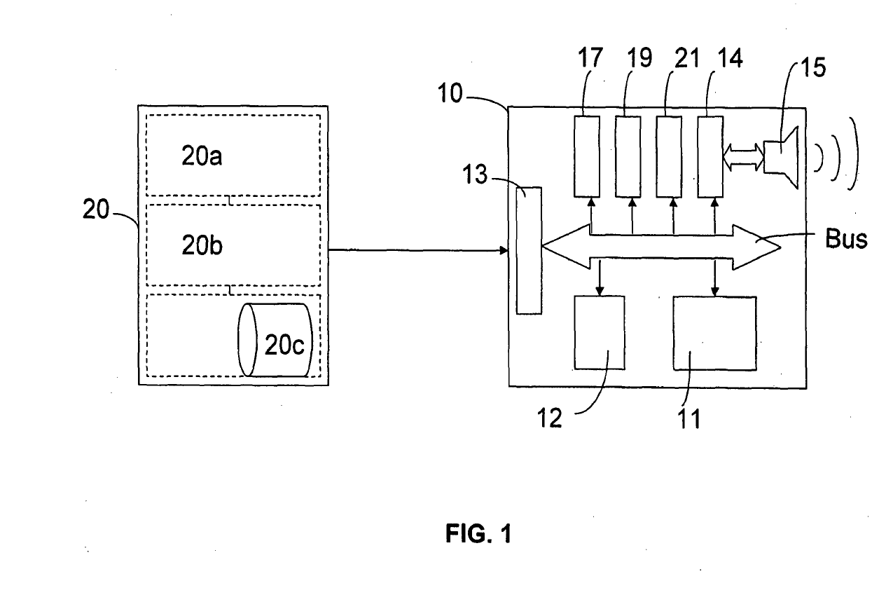

Turning to FIG. 1, shown is an exemplary jukebox 10 according to the invention. The jukebox 10 can include at least one memory 11 for storing songs. The memory 11 includes a digital memory to store information relating to the songs. The digital memory can also store a plurality of files containing the content. The memory 11 can also include other types of storage devices, such as CDs or vinyl albums. The digital memory of the memory 11 can be a hard drive, a collection of hard drives, or any other type of memory capable of storing large quantities of digital music files (e.g., RAM, ROM, DVD-RAM, DVD-R, DVD-RW, CD-R, CD-RW, memory stick, memory cards (CF, SD, XD), jump drive, mp3 player, personal digital assistant, and cell phone). Alternatively, the memory 11 can be stored outside of the jukebox 10 at a data center 20 or elsewhere.

Each jukebox 10 optionally has a display 21, which can display graphics, such as album covers, and text such as selection instructions and song titles. The display 21 can be in the form of printed materials, or can be in the form of a touch-screen, such that a user can make his selections by pressing points on a display screen. Alternatively, a user can enter selections or otherwise interact with jukebox 10 using a keyboard, mouse (e.g., user input device 19) or any other device capable of inputting information into jukebox 10. In one embodiment, the user can enter a selection remotely using a wireless device (e.g., PDA, cell phone, mp3 player, remote control, laptop computer, etc.). The jukebox 10 can also'have a processor 12, a communication interface 13, and an audio output unit including an audio reproduction circuit 14 coupled to at least one speaker 15 for replaying the content. The audio reproduction circuit 14 can include an audio card, a digital-to-analog converter, and means for decompressing compressed, digital files. Other optional parts of the jukeboxes 10 include a money detector 17, such as a coin, bill, and/or credit card acceptor, and a user input device 19, such as a keypad, manual keyboard, mouse, stylus, and other types of selection devices. The optional money detector 17 can include a device for electronic detection of a source of credit or money (i.e., credit card, device with a barcode or RFID tag).

In one embodiment, the jukebox 10 can be connected to a main data center 20. The data center 20 is preferably a collection of computer servers 20a, 20b, 20c, which can collectively or individually function to store digital music, store information used to manage the jukebox 10, store information regarding billing and/or royalty payments, and send the music to the jukebox 10. Alternatively, the jukebox 10 can function without a data center 20.

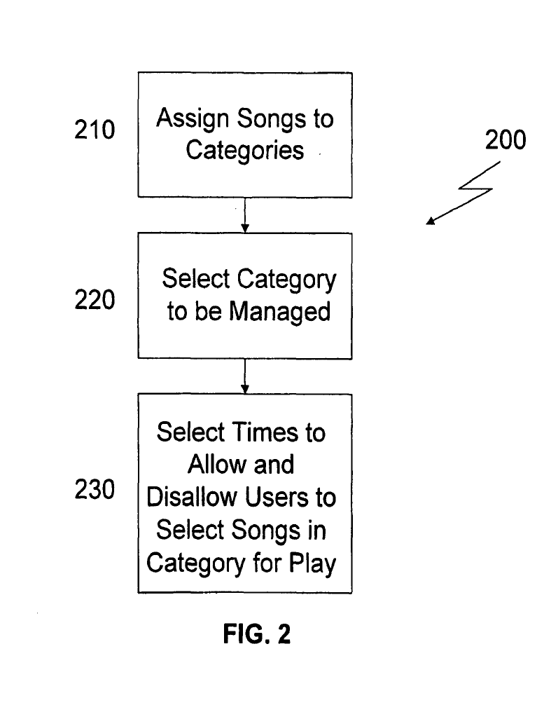

Turning to FIG. 2, an exemplary method 200 of managing the time during which songs can be selected for play by a user is depicted. At a first step 210, songs are assigned to categories. Content can be assigned to one or more categories. A category can include all content available for play on the jukebox or can contain as few as one discrete form of content (e.g., a particular song). In accordance with a preferred embodiment, this step 210 can include storing the categories that content has been assigned to in the memory 11. In accordance with another embodiment, if the content is stored digitally, the metadata associated with the digital file can be used as categories to which the content is assigned or the content can be automatically assigned to categories based on the metadata. In one embodiment, the metadata can be stored as part of the digital file storing the content. In another embodiment, the metadata can be stored separately from the digital file storing the content (e.g., in a separate file or in a database). If the metadata is stored separately from the digital file storing the content, the metadata may include information used to match the metadata to the corresponding file storing the entertainment content.

In one embodiment, content can be pre-assigned to categories by a manufacturer of the jukebox or by a content provider. In another embodiment, content can be assigned to categories by an administrator of the jukebox 10 using the user input device 19 or a remote device (e.g., computer, PDA, cell phone, laptop computer, and mp3 player). The administrator can assign content to pre-existing categories or to custom categories created by the administrator. Content need not be assigned to a category if an administrator does not wish to manage that particular content by category. The term “administrator” can refer, for example, to a person who manages the functions of a jukebox 10 (e.g., jukebox operator, jukebox owner), as opposed to a user, who can select content for play. In one embodiment, the administrator can gain access to the administrative functions of the jukebox using a password input into the user input device 19. In another embodiment, the administrator can give access to all or part of the administrator functions to a user. For example, the administrator of a content service can provide home users with access to administrative functions sufficient to control the play of certain kinds of content.

In a further embodiment, songs can be placed into categories according to any type of information that is be associated with a song. For example, a category can include songs of a particular musical genre, such as classical music, gospel, jazz, Latin pop, blues, rock, country music, electronic music, holiday music, melodic music, reggae, punk rock, hip hop, rap, movies/Broadway, new age, R&B/soul, and others. Other examples of categories include songs that contain explicit lyrics, songs with explicit album cover art, songs that relate to a particular holiday, songs performed by a specific artist or group, songs belonging to the same album, songs released in the same year, acoustical songs, songs containing lyrics, and songs of a particular length. If the jukebox 10 has the capability to play songs stored in the memory 11 and songs stored at the data center 20, one category can include songs that are stored locally and another can include songs that are stored remotely. If the jukebox 10 contains multiple types of storage mediums, such as digital memory, records, and CD's, categories can include songs that are stored on a particular storage medium. The categories can include songs that have been assigned the same maturity rating (e.g. “R”, “PG”, “PG13”, “T”, “E”, etc.) Additionally, an administrator can create a custom category and assign whichever songs are desired to that category, even if the songs have no obvious relationship to each other.

In another embodiment, an administrator manages only one discrete form of content (e.g., a particular song) at a time, in which case the administrator can select the content to be managed directly.

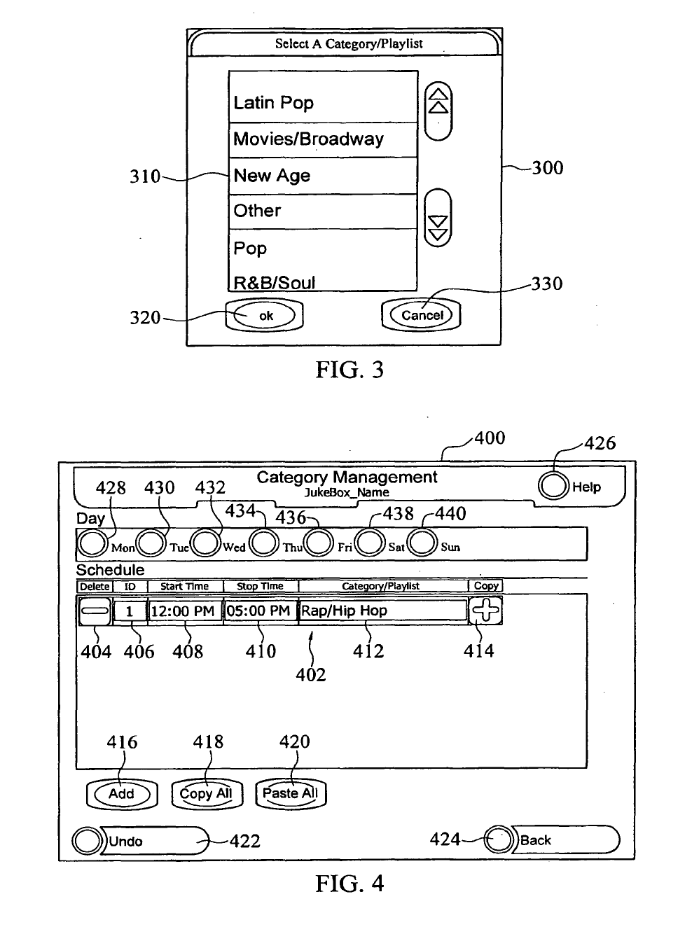

Next, at step 220, a category can be selected to manage. The administrator can select a category to manage using the user input device 19 or a remote device, such as a computer. Multiple categories may be selected to be managed and may be managed for the same, different, or overlapping time periods. In one embodiment, the category can be selected from a menu. FIG. 3, for example, shows a touch screen 300 displaying a menu of categories 310 that contain songs of a certain genre. The administrator can select the category desired by highlighting the category and pressing the “OK” button 320 or can exit the screen 300 without making a selection by pressing the “Cancel” button 330.

The next step 230, is to select a time period or multiple periods during which songs assigned to the selected category can be selected for play or to block by a user. An administrator can select the predetermined time periods using the user input device 19 or a remote device, such as a computer.

The predetermined time periods can be any length of time and can be customized to include any period of time having a beginning time and an ending time (e.g., months, weeks, days, hours, minutes, and/or seconds). In one embodiment, one or more predetermined time periods can be specified to start and stop within a longer time frame, such as an hour, day, week, month or year and then repeat during successive time frames. For example, a time period that includes the first ten minutes of every hour long time frame can be specified to recur every hour, so that a particular category of song could not be selected for play during the recurring time periods. As another example, time periods selected during a time frame of a week can reoccur every successive week so that certain categories may be precluded from play during weekdays and allowed during weekends. Of course, longer or shorter time periods and time frames are possible.

In one embodiment, the time period or periods selected during a time frame denotes the time periods when a user can not select songs in the selected category for play, but can select the songs for play at other times during the time frame. In another embodiment, the time period or periods selected during a time frame denotes the time periods when a user can select songs in the selected category for play, but can not select the songs for play at other times during the time frame.

FIG. 4 depicts an exemplary embodiment of the invention having a touch screen 400 on which time periods can be selected in increments of hours and minutes within the time frame of a week. The selected time periods automatically recur in subsequent time frames so that a selection of a time period on any day of the week will recur on the same day of the following week. FIG. 4 shows a touch screen 400 containing a row of data 402 that is used to determine when songs in a category can not be selected for play by a user. The row of data is made up of a “Delete” button 404 to delete the row, an “ID” text box 406 to numerically designate the row, a “Start Time” 408 and a “Stop Time” 410 text box to designate the time period, a “Category/Playlist” text box 412 to designate the selected category, and a “Copy” 414 button to copy the row of data. The screen also contains an “Add” button 416 to begin a new row of data for additional time periods during the selected day, a “Copy All” button 418 to copy all rows of data on the screen 400 at one time, a “Paste All” button 420 to paste data to the screen 400 that may have been copied, an “Undo” button 422 to undo previous action, a “Back” button 424 to return to a previous screen, and a “Help” button 426 to receive instructions. Additional days of the week can be selected for scheduling by pressing the button associated with that day. The time periods for any day of the week can be scheduled to be the same as or different than other days of the week.

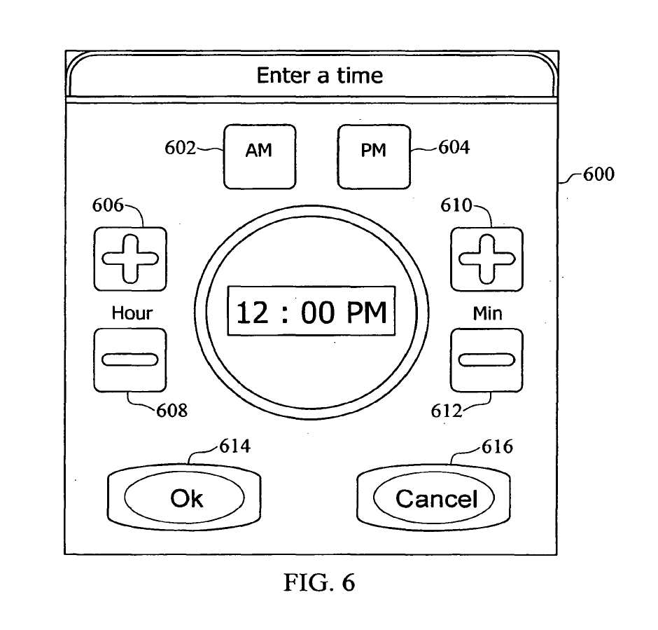

In this embodiment, touching the “Start Time” 408 or “Stop Time” text box 410 will pop up a new clock key pad 600 on the screen as shown in FIG. 6, on which the time can be selected. The clock key pad 600 shown in FIG. 6 includes an “AM” button 602, a “PM” button 604, an add hour button 606, a subtract hour button 608, an add minute button 610, and a subtract minute button 612 to set the desired time. The clock key pad 600 also includes an “OK” button to accept the input time and a “Cancel” button to return to the previous screen without making a time selection.

Touching the “Category/Playlist” text box 412 will pop up a list of categories, as shown in FIG. 3, that can be selected by touching the category and then pressing the “OK” button. In FIG. 4, the category and time period has been selected so that songs assigned to the category of “Rap/Hip Hop” will be not be allowed to be selected for play by a user from 12:00 PM until 5:00 PM each Monday and will be available to be selected for play at other times each Monday. Additional days of the week can be selected by pressing the button 428, 430, 432, 434, 436, 438, and 440 associated with that day and the time periods for those days can be scheduled to be the same as or different than other days of the week.

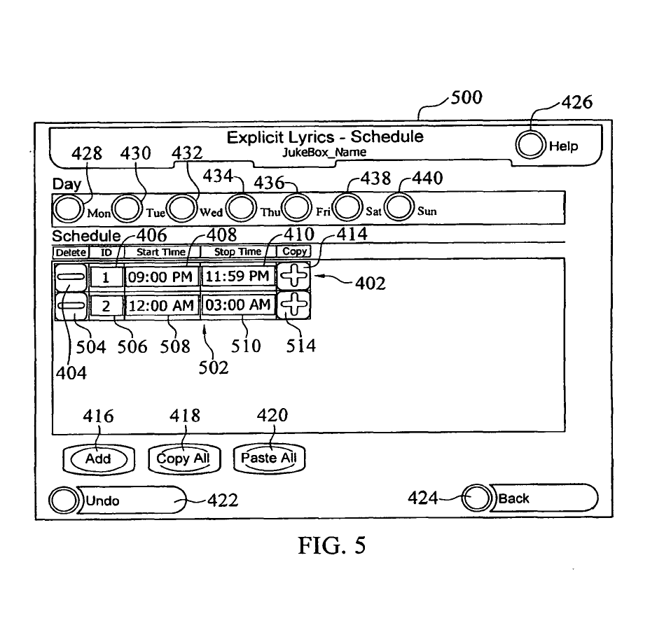

FIG. 5 depicts a touch screen 500 having an interface in which multiple time periods have been scheduled within a week long time frame. The available buttons and text boxes shown in FIG. 5 are the same as shown on the touch screen of FIG. 4 with the exception that the text box for “Category/Playlist” 412 is not available in FIG. 5 because the category of songs that contain “Explicit Lyrics” was selected for management on a previous screen. FIG. 5 also includes a second row of data 502 that includes a “Delete” button 504 to delete the row, an “ID” text box 506 to numerically designate the row, a “Start Time” 508 and a “Stop Time” 510 text box to designate the time period, and a “Copy” button 514 to copy the row of data.

In FIG. 5, a first time period has been selected from 9:00 PM to 11:59 PM every Monday in the first row of data 402 and a second time period has been selected from 12:00 AM to 3:00 AM every Monday in the second row of data 502 during which time songs assigned to the category of songs containing “Explicit Lyrics” can be selected for play. Accordingly, songs assigned with the category can not be played at other time periods on Monday.

As described above, embodiments of the invention provide that each jukebox 10 has a display 21, which can display identifying information that relates to the songs that can be selected for play by a user. The identifying information can include information such as the name of the content, the name of the artist, the name of the album that the content is included in, the playing time of the content, the year the content was released, album cover graphics, and other information. The identifying information can be arranged as a list that is available for viewing by a user. The list can be shown by the display 21 as a printed list or on a video screen, such as a touch screen, as an electronic list.

In one embodiment, when a song is not available for selection for play, the display 21 can hide identifying information about the song from the user. If the display 21 includes a video screen, the identifying information can be hidden merely by removing it from the list so that it can not be seen by a user.

In another embodiment, when a song is blocked from being selected for play by a user, the display 21 can indicate to a user that the song is not available for selection for play by marking the song's identifying information in the list in some way. For example, the song's identifying information can be highlighted or crossed out. In another embodiment, the display 21 can include information with the song's identifying information that describes the time at which the song can be selected for play or the times during which the song can not be selected for play. In another embodiment, the display 21 can include information with the song's identifying information that indicates that the song can be selected for play, but will be stored in a queue to be played at a later time.

The processes and devices described above illustrate preferred methods and typical devices of many that could be used and produced. The above description and drawings illustrate embodiments, which achieve the objects, features, and advantages of the present invention. However, it is not intended that the present invention be strictly limited to the above-described and illustrated embodiments. Additionally, any modifications, though presently unforeseeable, of the present invention that come within the spirit and scope of the following claims should be considered part of the present invention.

1. A method of controlling a jukebox, comprising:
assigning at least one song to a category recognized by the jukebox; and
programming the jukebox to prevent songs assigned to the category the at least one song from playing during a first predetermined time period.

2. The method of claim 1, wherein the first predetermined time period is repeated periodically.

3. The method of claim 1, further comprising programming the jukebox to allow the at least one song songs assigned to the category to play during a second predetermined time period.

4. The method of claim 1, further comprising programming the jukebox to prevent the at least one song songs assigned to the category from playing during a plurality of first predetermined time periods.

5. The method of claim 4, further comprising programming the jukebox to allow the at least one song songs assigned to the category to play during a plurality of second predetermined time periods.

6. The method of claim 5, wherein the plurality of first predetermined time periods and the plurality of second predetermined time periods are repeated periodically.

7. The method of claim 1, wherein the at least one song is assigned to a plurality of categories.

8. The method of claim 1, further comprising assigning at least one song to a second category, and programming the jukebox to prevent the at least one song songs assigned to the second category from playing during a second predetermined time period.

9. The method of claim 8, further comprising programming the jukebox to allow the at least one song songs assigned to the second category to play during a third time period.

10. The method of claim 1, wherein assigning the at least one song to the category comprises associating metadata with the at least one song.

11. The method of claim 1, further comprising assigning the at least one song to the category using an input device associated with the jukebox.

12. The method of claim 11, wherein the input device comprises at least one device from a group consisting of a touch screen, a keyboard, a mouse, a PDA, a cell phone, an mp3 player, a remote control, and a computer.

13. The method of claim 1, wherein the category consists of songs having at least one common attribute and wherein the at least one common attribute is selected from the group consisting of the same musical genre, explicit lyrics, explicit album cover art, relating to the same holiday, performed by the same artist or group, the same album, and the same year of release.

14. A program encoded on a computer readable medium for managing songs that may be played by a device, said program, when executed by a processor, causing the processor to execute steps comprising:
allowing selection of a category of songs to manage, the category of songs consisting of a plurality of songs having at least one common attribute;
allowing selection of a time period during which songs belonging to the category may not be played by the device; and
preventing the songs belonging to the selected category from being played by the device during the selected time period.

15. The method program of claim 14, further comprising allowing the songs belonging to the selected category to play during time periods other than the selected time period.

16. The program of claim 14, wherein the selected time period is repeated periodically.

17. The program of claim 16, wherein the selected time period is repeated weekly.

18. The program of claim 16, wherein the selected time period is repeated daily.

19. The program of claim 14, wherein the songs belonging to the selected category are prevented from being played by preventing access to information identifying the songs.

20. A program encoded on a computer readable medium for managing songs that may be played by a device, said program, when executed by a processor, causing the processor to execute steps comprising:
allowing selection of a plurality of categories of songs to manage, each category of songs consisting of a plurality of songs having at least a common attribute;
allowing a person to select a plurality of time periods for each of the plurality of categories during which songs belonging to each of the plurality of categories may not be played by the device; and
preventing the songs belonging to the selected plurality of categories from being played by the device during their corresponding selected plurality of time periods.

21. The program of claim 20, further causing the processor to execute the step of allowing the songs belonging to the selected plurality of categories to play during time periods other than during their corresponding selected plurality of time periods.

22. A jukebox, comprising:
a memory for storing a plurality of songs, at least one song being assigned to a category;
an audio output unit for playing the plurality of songs; and
a processor for transferring the plurality of songs from the memory to the audio output unit;
wherein the memory stores a computer program, which may be executed by the processor to cause the processor to allow selection of a predetermined time period and prevent the at least one song assigned to the category from playing during a predetermined time period.

23. The jukebox of claim 22, wherein the program further causes the processor to allow the at least one song assigned to the category to play during times other than the predetermined time period.

24. The jukebox of claim 22, wherein the memory comprises a digital memory and wherein the plurality of songs are stored as digital files on the digital memory.

25. The jukebox of claim 24, wherein the digital memory stores metadata relating to the songs, and where the songs are assigned to the category according to their respective metadata.

26. The jukebox of claim 22, further comprising an input device.

27. The jukebox of claim 26, wherein the input device comprises at least one device from a group consisting of a touch screen, a keyboard, a mouse, a PDA, a cell phone, an mp3 player, a remote control, and a computer.

28. The jukebox of claim 26, wherein the input device is for allowing a person to determine the time period.

29. The jukebox of claim 26, wherein the input device is for allowing a person to assign the at least one song to the category.

30. The jukebox of claim 22, wherein pluralities of songs are assigned to a plurality of respective categories and wherein the computer program allows a person to select a plurality of categories and a plurality of time periods for each of the selected multiple categories during which the processor prevents the songs assigned to the selected plurality of categories from playing.

31. The jukebox of claim 30, wherein the selected times repeat at regular intervals.
